(19) United States
(12) Patent Application Publication
(10) Pub. No.: US 2021/0101676 A1
(43) Pub. Date: Apr. 8, 2021

(54) SPAR FOR DUCTED-ROTOR AIRCRAFT

(71) Applicant: Bell Textron Inc., Fort Worth, TX (US)

(72) Inventors: Karl Schroeder, Southlake, TX (US); William Anthony Amante, Grapevine, TX (US); Joseph Richard Carpenter, JR., Kennedale, TX (US); David G. Carlson, North Richland Hills, TX (US)

(73) Assignee: Bell Textron Inc., Fort Worth, TX (US)

(21) Appl. No.: 16/593,998

(22) Filed: Oct. 5, 2019

(51) Int. Cl. B64C 27/32; B64F 5/10

(52) U.S. Cl. CPC B64C 27/32; B64F 5/10

(57) ABSTRACT

An annular spar for a ducted-rotor of an aircraft may be fabricated from composite material, such as carbon-fiber-reinforced plastic (CFRP). The spar may include an annular plate, a first circumferential flange that extends from an outer edge of the plate, and a second circumferential flange that extends from an inner edge of the plate. The first and second circumferential flanges may taper inwardly toward a center axis of the spar. The spar may be constructed of a plurality of layers of CFRP. One or more of the layers may be fabricated from a single ply of CFRP, and one or more other layers may be fabricated from a plurality of plies of CFRP. The spar may exhibit a coefficient of thermal expansion (CTE) that allows an associated tip gap to remain essentially constant throughout a range of operating temperatures.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Ducted-rotor aircraft have at least one ducted rotor for providing lift and propulsion forces. Each ducted rotor has aerodynamic ductwork, such as a cowling, that shapes and/or modifies characteristics of inlet air that passes by the blades. Such ductwork typically includes an aerodynamic exterior skin and internal structure, such as annular spars, that support the exterior skin. A tip gap exists between tips of the blades and the exterior skin. Maintaining tight tip-gap tolerances is desirable because as tip gap narrows, performance characteristics of the rotor, such as thrust, improve.

### BRIEF DESCRIPTION OF THE DRAWINGS

FIG. 1A is an oblique view of an aircraft with its ducted rotors in a horizontal orientation.

FIG. 1B is an oblique view of the aircraft depicted in FIG. 1A, with its ducted rotors in a vertical orientation.

FIG. 2 is an oblique view of a duct of the aircraft depicted in FIG. 1A.

FIG. 3 is an oblique view of the duct depicted in FIG. 2, with an outer skin of the duct removed to illustrate internal components of the duct.

FIG. 4 is an oblique view of a forward composite spar component of the duct depicted in FIG. 3.

FIG. 5 is an oblique view of an aft composite spar component of the duct depicted in FIG. 3.

FIG. 6 is an oblique view of a tooling apparatus that may be used to produce the forward and aft spars illustrated in FIGS. 4 and 5, respectively.

FIG. 7 is a front view of the tooling apparatus depicted in FIG. 6.

FIG. 8 is a top view of the tooling apparatus depicted in FIG. 6.

FIG. 9 is an oblique view of a portion of the tooling apparatus depicted in FIG. 6, with a single ply of composite material laid up thereon.

FIG. 10 is an oblique view of a ply of composite material that is pre-formed for application to the single ply of composite material depicted in FIG. 9.

FIG. 11 is an oblique view depicting three pre-formed plies of composite material, such as the one depicted in FIG. 10, applied to the single ply of composite material depicted in FIG. 9.

FIGS. 12A-12H are top views of respective layers of composite material applied during an example process of producing a spar such as the forward spar illustrated in FIG. 4 or the aft spar illustrated in FIG. 5.

FIG. 13 is an oblique view of a spar produced using the example process illustrated in FIGS. 12A-12H, with the spar enclosed in preparation for a curing process that is performed on the composite material.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

Annular spars are disclosed herein for use in aircraft such as ducted-rotor aircraft, for example.

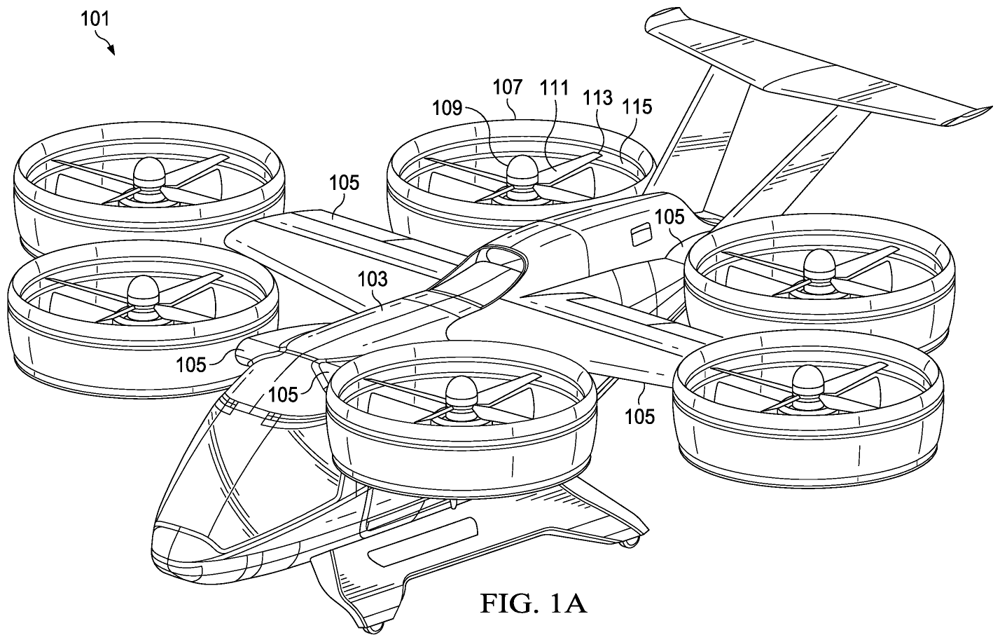

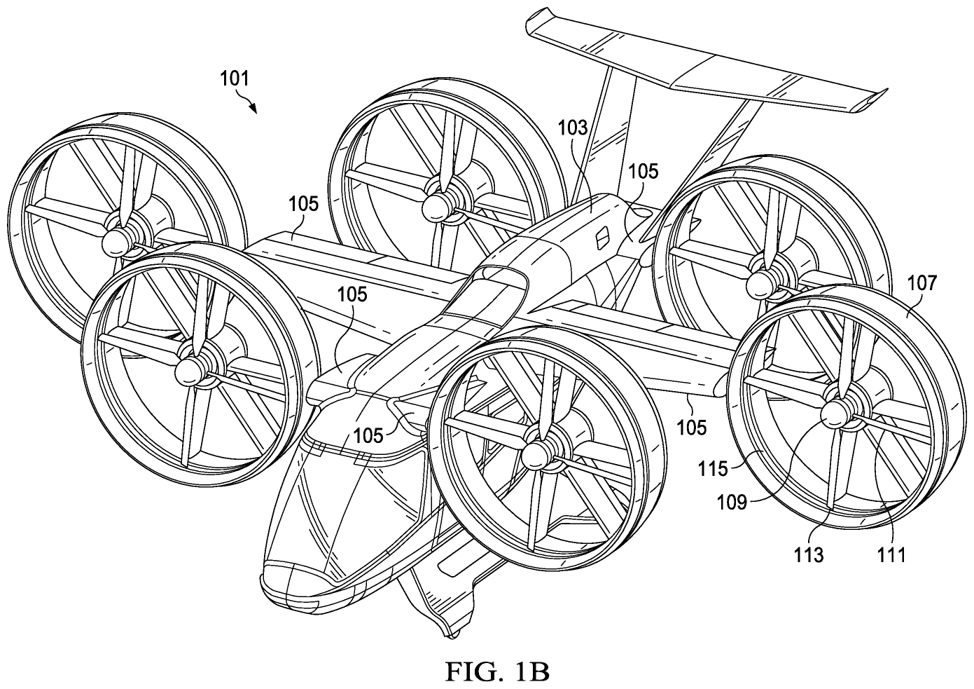

FIGS. 1A and 1B are oblique views of a ducted-rotor aircraft 101. Aircraft 101 comprises a fuselage 103 with a plurality of fixed wings 105 extending therefrom and a plurality of pivotable ducts 107. As shown, a duct 107 is located at an end of each wing 105. Each duct 107 houses a powerplant for driving an attached rotor 109 in rotation. Each rotor 109 has a plurality of blades 111 configured to rotate within ducts 107.

The position of ducts 107, and optionally the pitch of blades 111, can be selectively controlled to selectively control direction, thrust, and lift of rotors 109. For example, ducts 107 can be repositioned from respective horizontal orientations as shown in FIG. 1A to respective vertical orientations as shown in FIG. 1B. Each blade 111 defines a tip 113 that is spaced from an inner surface 115 of a corresponding duct 107 through a distance that may be referred to as a tip gap.

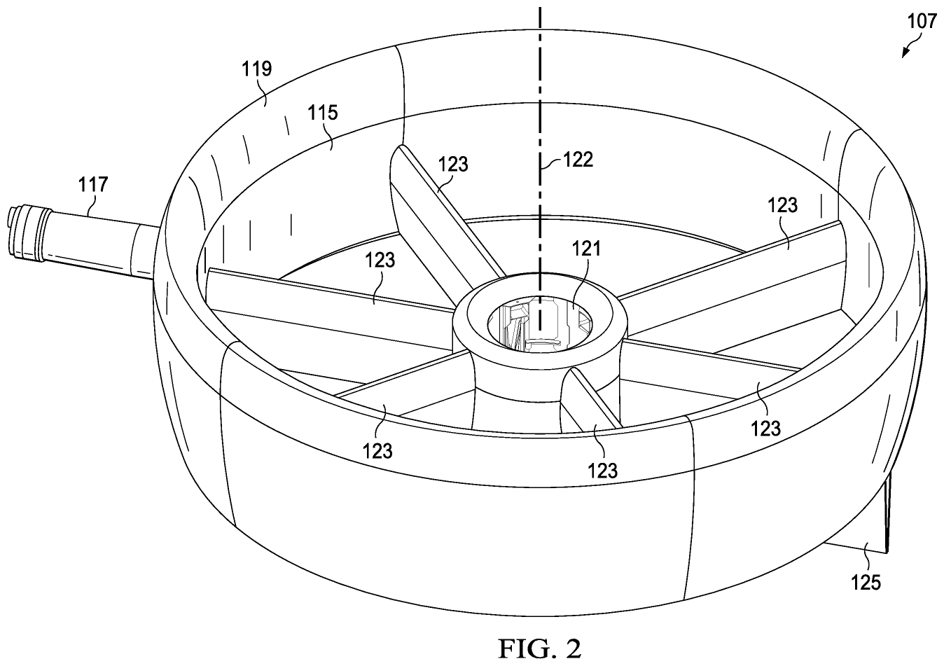

FIG. 2 is an oblique view of a duct 107 of aircraft 101. Duct 107 is depicted in FIG. 2 without rotor 109. As shown, duct 107 includes a spindle 117 that extends outward and that facilitates pivotable attachment of duct 107 to a corresponding wing 105 of aircraft 101. Duct 107 may include one or more section of cowling 119 that form an outer skin of duct 107. As shown, cowling 119 defines inner surface 115 of duct 107 such that tips 113 of blades 111 of rotor 109 are spaced from inner surface 115 during rotation of blades 111 through a predetermined tip gap.

Duct 107 further includes a central hub 121 that is configured to receive a rotor 109 and/or other components. Hub 121 defines an axis 122 of rotation about which blades 111 of rotor 109 rotate. Axis 122 may be referred to as a center axis of duct 107. Duct 107 may further include a plurality of stators 123 that extend outwardly from the hub 121 and that either abut inner surface 115 or extend through inner surface 115 to an interior of duct 107. In accordance with the illustrated configuration, duct 107 includes six stators 123 that extend radially outward from hub 121. As shown, stators 123 are unequally spaced about hub 121. It should be appreciated that duct 107 may be alternatively configured with more or fewer stators 123. It should further be appreciated that duct 107 may be alternatively configured with different spacing of stators 123 about hub 121. Duct 107 may further include one or more vanes 125 that may be pivotally attached to respective stators 123, such that vanes 125 may be rotated to facilitate changes of direction, turning, etc. during flight of aircraft 101.

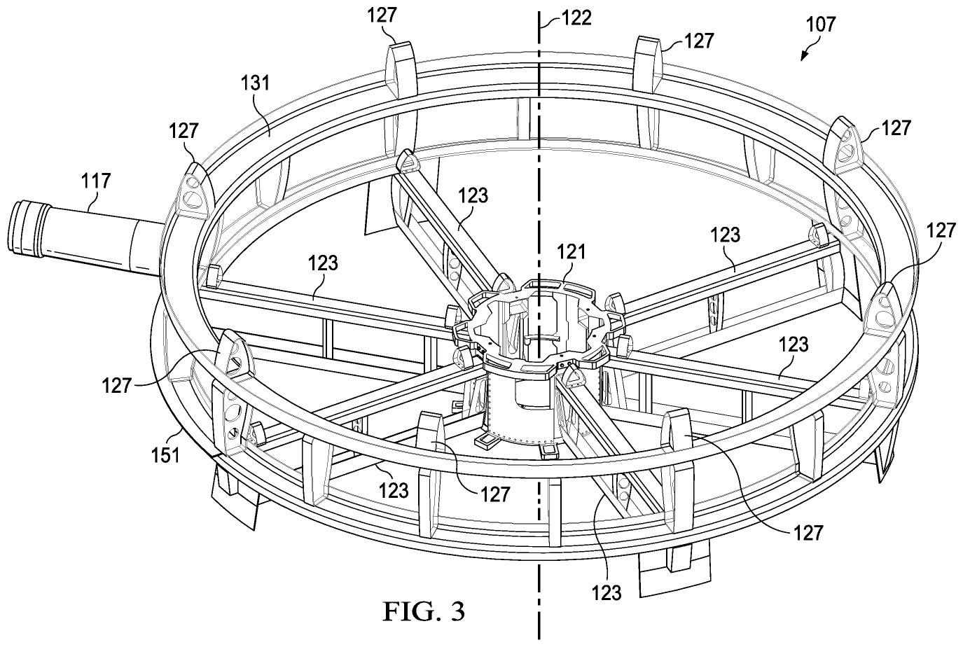

FIG. 3 is an oblique view of duct 107 with cowling 119 removed to illustrate inner components of duct 107. Included among inner structural members of duct 107 are an annular upper spar 131 and an annular lower spar 151. Axis 122 may be referred to as a center axis of upper spar 131 and lower spar 151. As shown, one or more other components, such as ribs 127 for example, may be attached to upper spar 131. Ribs 127 may be configured to support portions of cowling 119. As additionally shown, one or more other components, such as stators 123, may be attached to lower spar 151.

One or both of upper spar 131 and lower spar 151 may be constructed of composite material. In the instant disclosure, composite material preferably refers to plies of a fiber-reinforced plastic (FRP) composition that includes filament fibers, such as carbon fibers for example, embedded in a thermoset polymer matrix material such as a thermoplastic resin. Preferably the fibers within the plies are woven and the plies are pre-impregnated with resin. To illustrate, upper spar 131 and lower spar 151 may be constructed from one or more layered plies of carbon-fiber-reinforced plastic (CFRP) using techniques described in more detail elsewhere herein. In alternative embodiments, plies may have unidirectional fibers, and resin may be brushed onto plies or infused through a resin-transfer process.

Upper spar 131 may be referred to as forward spar 131 because, for example, when ducts 107 are positioned vertically as shown in FIG. 1B with the blades 111 of rotors 109 rotating, air will move into ducts 107 past forward spar 131 as rotors 109 generate thrust that causes aircraft 101 to move in a forward direction. Lower spar 151 may alternatively be referred to as aft spar 151 because as air moves through ducts 107 while the blades 111 of rotors 109 are rotating, the air will move past aft spar 151 and be exhausted away from ducts 107, for example in an aft direction as aircraft 101 moves in a forward direction.

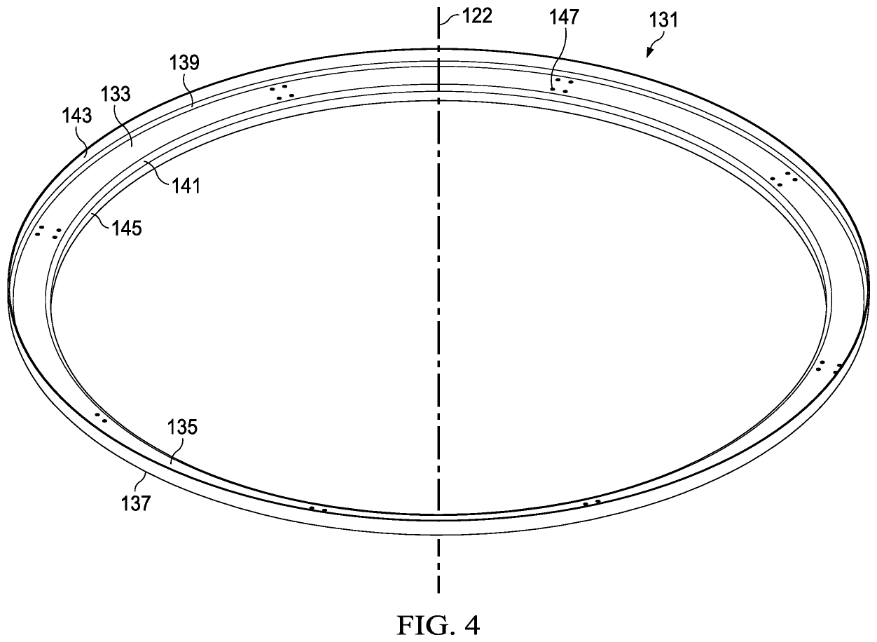

FIG. 4 is an oblique view of forward spar 131, oriented horizontally. In accordance with the illustrated configuration, forward spar 131 includes an annular plate 133 that defines an upper surface 135 and an opposed lower surface 137. Plate 133 further defines a circumferential outer edge 139 and a circumferential inner edge 141. Forward spar 131 further includes a first circumferential flange 143 that extends away from upper surface 135 along outer edge 139 of plate 133. As shown, first circumferential flange 143 may be configured such that it tapers inwardly from outer edge 139 of plate 133, toward axis 122. Forward spar 131 further includes a second circumferential flange 145 that extends away from lower surface 137 along inner edge 141 of plate 133. As shown, second circumferential flange 145 may be configured such that it tapers inwardly from inner edge 141 of plate 133, toward axis 122. Forward spar 131 may be configured to facilitate attachment of one or more other components thereto. For example, as shown forward spar 131 defines a plurality of apertures 147 that extend through plate 133. Apertures 147 may be configured, for example, to receive fasteners to secure ribs 127 to forward spar 131.

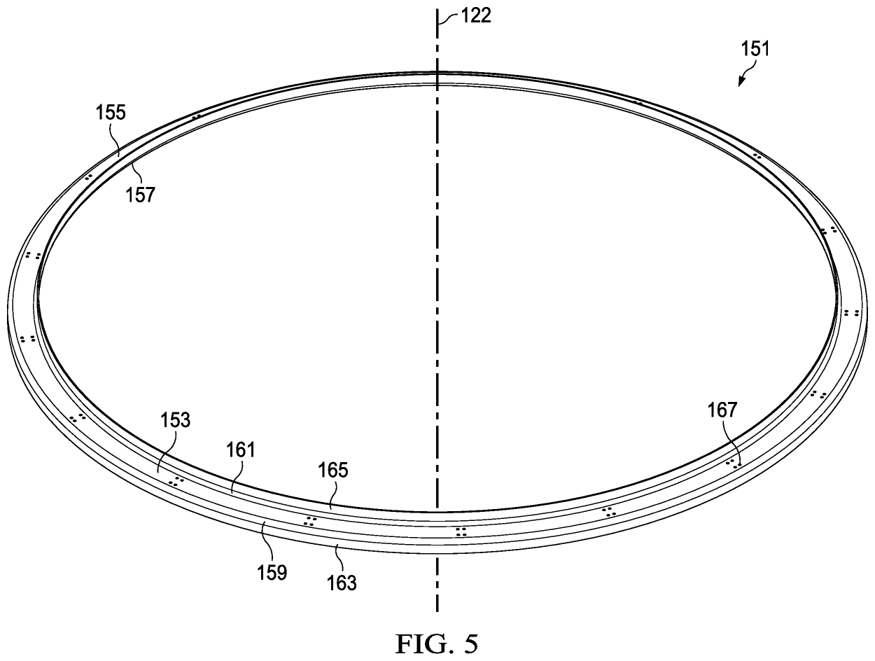

FIG. 5 is an oblique view of aft spar 151, oriented horizontally. In accordance with the illustrated configuration, aft spar 151 includes an annular plate 153 that defines an upper surface 155 and an opposed lower surface 157. Plate 153 further defines a circumferential outer edge 159 and a circumferential inner edge 161. Aft spar 151 further includes a first circumferential flange 163 that extends away from lower surface 157 along outer edge 159 of plate 153. As shown, first circumferential flange 163 may be configured such that it tapers inwardly from outer edge 159 of plate 153, toward axis 122. Aft spar 151 further includes a second circumferential flange 165 that extends away from upper surface 155 along inner edge 161 of plate 153. As shown, second circumferential flange 165 may be configured such that it tapers inwardly from inner edge 161 of plate 153, toward axis 122. Aft spar 151 may be configured to facilitate attachment of one or more other components thereto. For example, as shown aft spar 151 defines a plurality of apertures 167 that extend through plate 153. Apertures 167 may be configured, for example, to receive fasteners to secure stators 123 to aft spar 151.

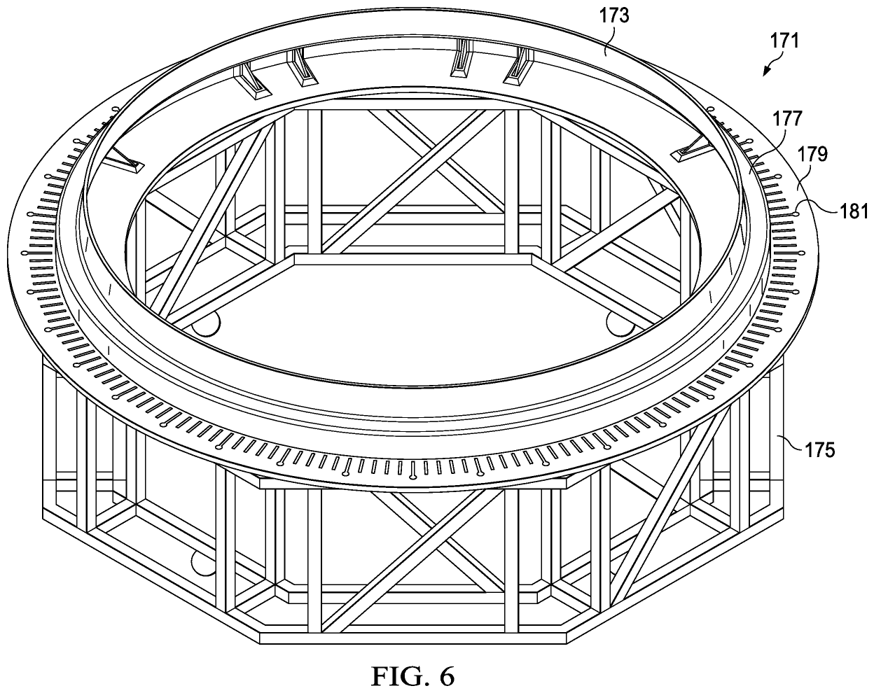

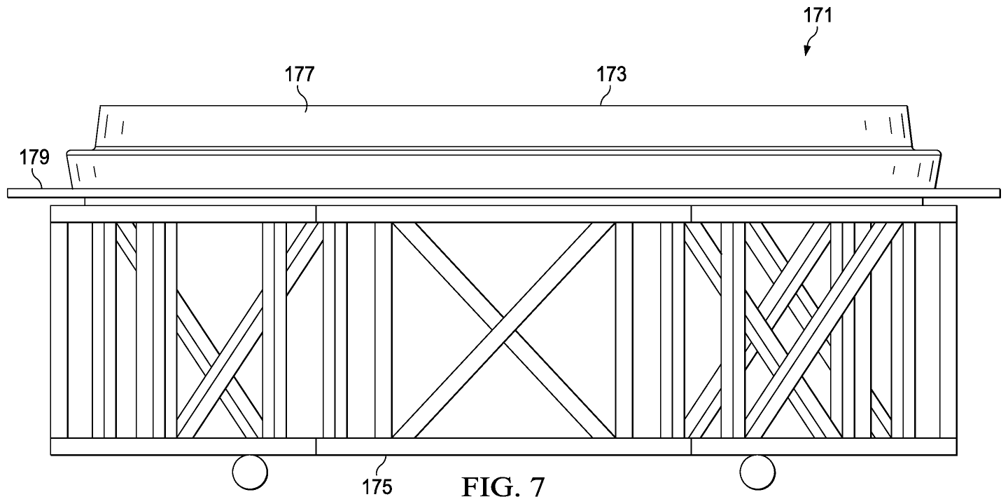

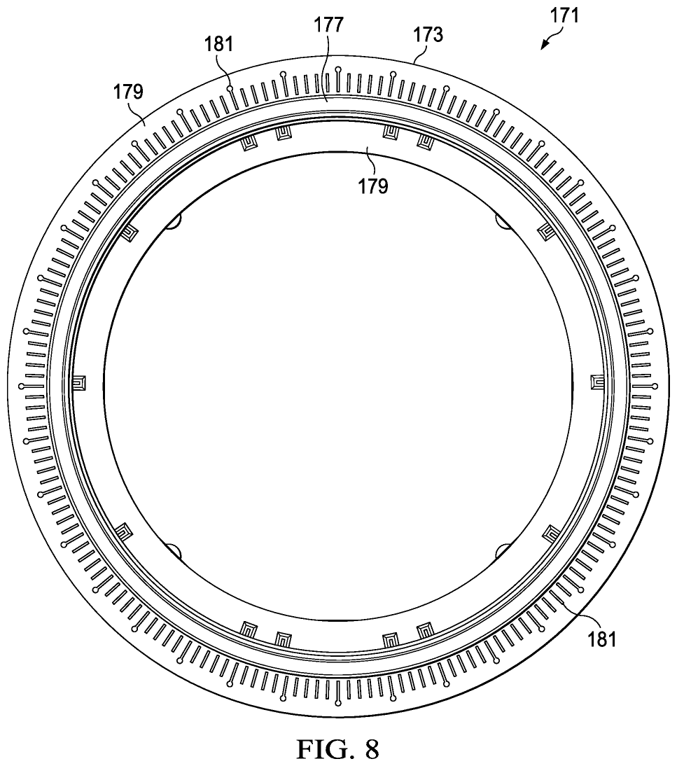

FIGS. 6-8 depict various views of a tooling apparatus 171 that may be used to produce an annular spar, such as forward spar 131 and aft spar 151 for example. As shown, tooling apparatus 171 includes an annular layup tool 173 and framework 175 upon which layup tool 173 may be supported. As shown, layup tool 173 includes an upper portion 177 and a lower portion 179. Upper portion 177 may be configured to impart a desired spar geometry to one or more layers of CFRP that are laid up on upper portion 177. Lower portion 179 may be shaped substantially like an annular plate, and may include one or more markings 181 that designate respective circumferential distances around the perimeter of upper portion 177. Tooling apparatus 171 may be constructed so as to have two or more inter-connectable sections, for instance such that tooling apparatus 171 may be fully assembled as shown during layup of a spar, and may be at least partially disassembled to facilitate release and/or removal of a finished spar from tooling apparatus 171. One or more portions of tooling apparatus 171 may be constructed from composite material, such as layup tool 173 for instance. Framework 175 may be constructed from metal, such as steel for instance.

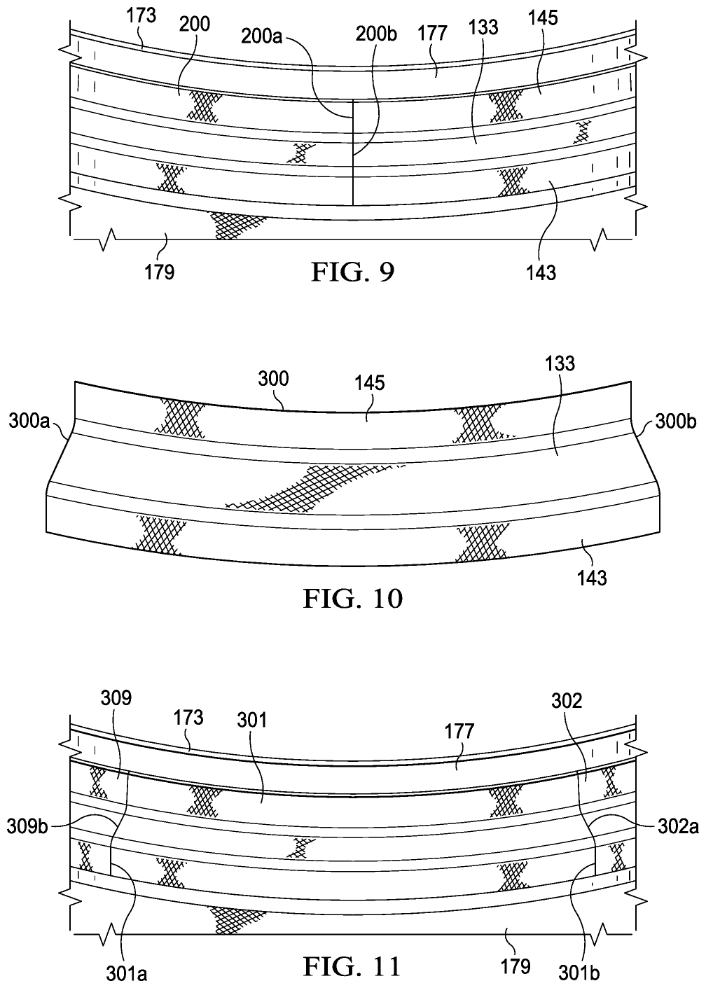

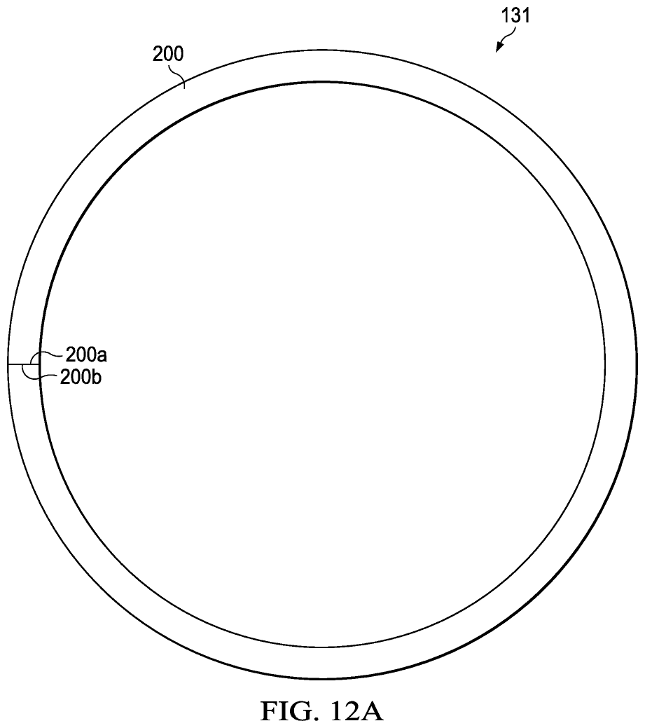

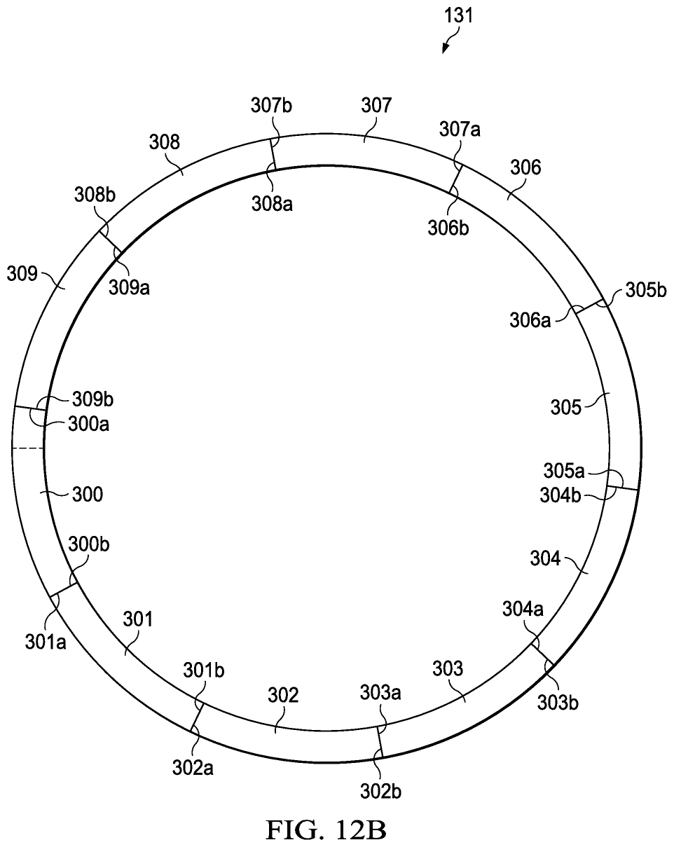

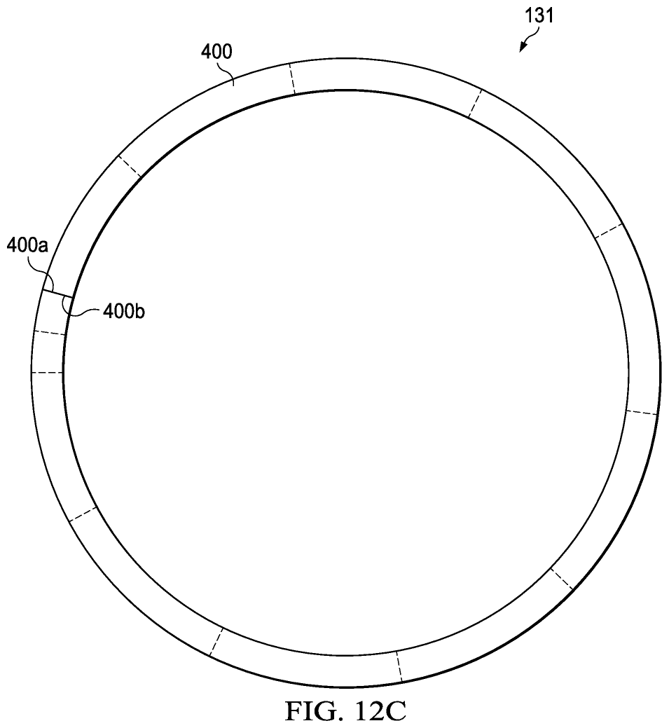

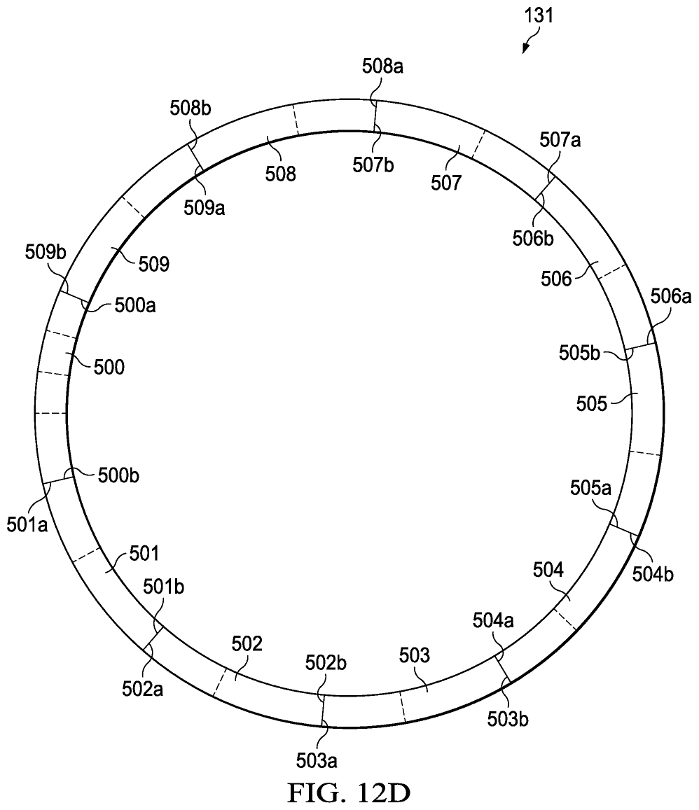

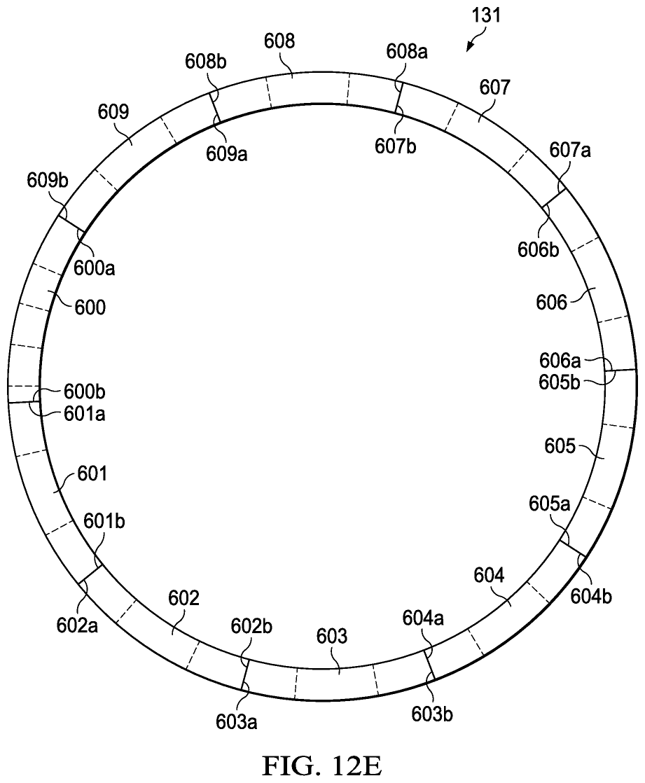

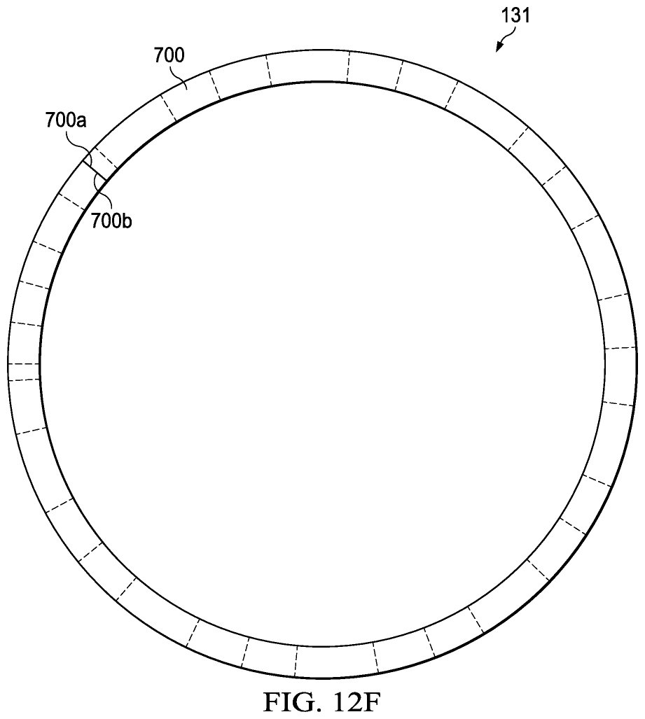

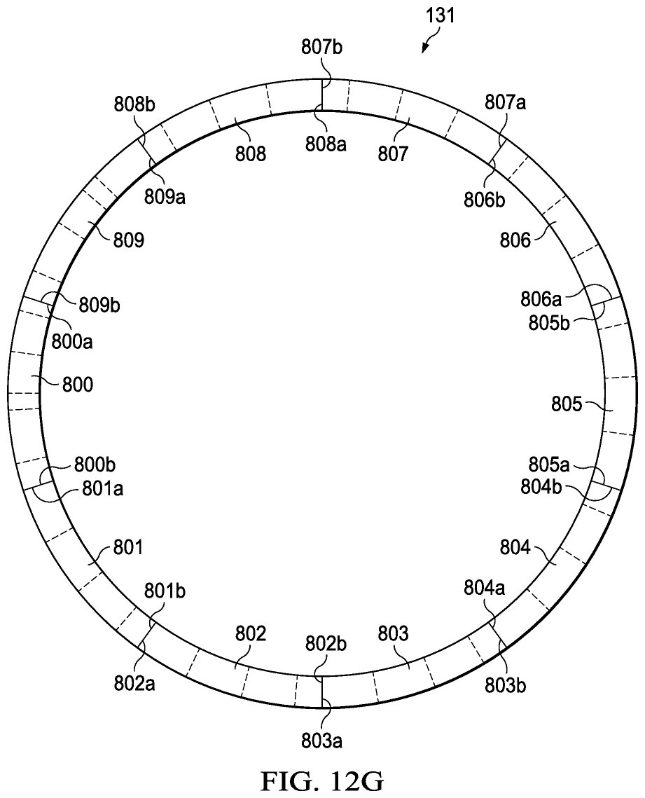

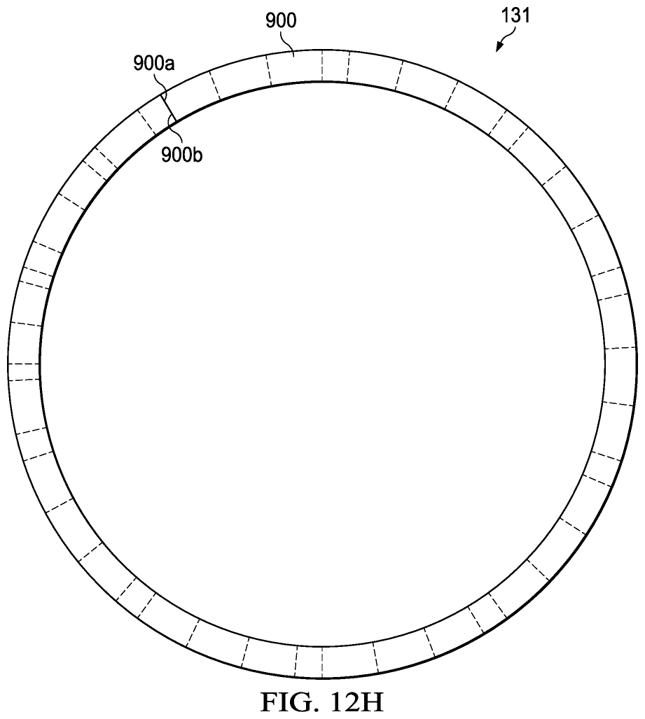

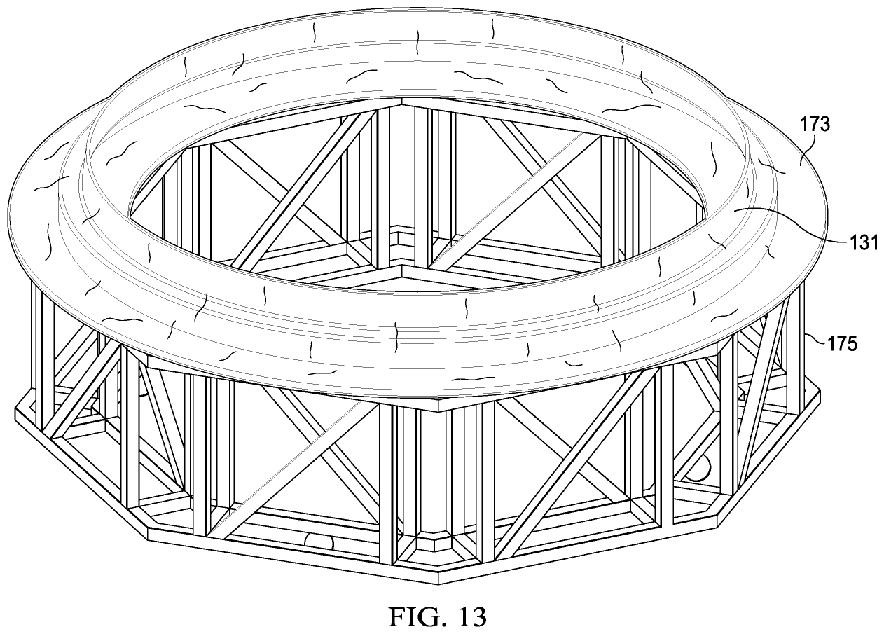

Tooling apparatus 171 can be used to fabricate composite-material spars, such as forward spar 131 and/or aft spar 151 for example. To illustrate, tooling apparatus 171 may be used in an example process of fabricating forward spar 131. In accordance with the example fabrication process, a single ply 200 of CFRP having a first end 200a and an opposed second end 200b may be laid up on upper portion 177 of layup tool 173, as shown in FIGS. 9 and 12A. Single ply 200 of CFRP may be, for example T1100±45° CFRP. The CFRP of single ply 200 may be laid up on upper portion 177 of layup tool 173 such that intersections in the weave are oriented toward axis 122. Single ply 200 of CFRP may have a length from first end 200a to second end 200b such that when single ply 200 is laid up on upper portion 177, first and second ends 200a and 200b, respectively, abut each other, thereby creating a single butt splice in the first layer of CFRP of forward spar 131.

Further in accordance with the example fabrication process of forward spar 131, a second layer of CFRP may be applied to the first layer. The second layer of forward spar 131 may include a plurality of plies of CFRP that are applied to the first layer. For example, as shown in FIGS. 10, 11, and 12B, the second layer of forward spar 131 may include ten plies 300, 301, 302, . . . 309 of CFRP. Each ply of CFRP may have a first end (e.g., 300a, 301a, 302a, . . . 309a) and an opposed second end (e.g., 300b, 301b, 302b, . . . 309b). Plies 300, 301, 302, . . . 309 of CFRP may be, for example T1100 0°-90° CFRP.

Each ply 300, 301, 302, . . . 309 of CFRP may be laid up on a preform tool (not shown) and trimmed before being applied to the first layer of forward spar 131. The preform tool may cause each ply 300, 301, 302, . . . 309 of CFRP to conform to a surface geometry of the first layer of forward spar 131. Plies 300, 301, 302, . . . 309 of CFRP may be laid up on the preform tool such that alternating filaments of carbon fiber in the CFRP, for example the 0° filaments, are aligned (e.g., radially) toward axis 122.

As shown in FIGS. 11 and 12B, when applied to the first layer of forward spar 131, the ends of each ply 300, 301, 302, . . . 309 of CFRP may abut corresponding ends of adjacent plies at respective joints, for example second end 301b of ply 301 abuts first end 302a of ply 302, second end 302b of ply 302 abuts first end 303a of ply 303, and so on, thereby creating ten butt splices in the second layer of CFRP of forward spar 131. As shown in FIG. 12B, plies 300, 301, 302, . . . 309 of CFRP may be applied to the first layer such that the butt joints of the second layer are offset from the butt joint of the first layer.

Further in accordance with the example fabrication process of forward spar 131, a third layer of CFRP may be applied to the second layer. The third layer of forward spar 131 may include a single ply 400 of CFRP that is applied to the second layer. Single ply 400 of CFRP may be, for example T1100±45° CFRP. The CFRP of single ply 400 may be applied to the second layer such that intersections in the weave are oriented toward axis 122. Single ply 400 of CFRP may have a length from a first end 400a to a second end 400b such that when single ply 400 is applied to the second layer, first and second ends 400a and 400b, respectively, abut each other, thereby creating a single butt splice in the third layer. As shown in FIG. 12C, single ply 400 of CFRP may be applied to the second layer such that the butt joint of the third layer is offset from the butt joints of each of the lower layers.

Further in accordance with the example fabrication process of forward spar 131, a fourth layer of CFRP may be applied to the third layer. The fourth layer of forward spar 131 may include a plurality of plies of CFRP that are applied to the third layer. For example, as shown in FIG. 12D, the fourth layer of forward spar 131 may include ten plies 500, 501, 502, . . . 509 of CFRP. Each ply of CFRP may have a first end (e.g., 500a, 501a, 502a, . . . 509a) and an opposed second end (e.g., 500b, 501b, 502b, . . . 509b). Plies 500, 501, 502, . . . 509 of CFRP may be, for example T1100 0°-90° CFRP. Similar to fabrication of the second layer, plies 500, 501, 502, . . . 509 of CFRP may be laid up on the preform tool and trimmed before being applied to the third layer. Plies 500, 501, 502, . . . 509 of CFRP may be laid up on the preform tool such that alternating filaments of carbon fiber in the CFRP, for example the 0° filaments, are aligned (e.g., radially) toward axis 122.

As shown in FIG. 12D, when applied to the third layer, the ends of each ply 500, 501, 502, . . . 509 of CFRP may abut corresponding ends of adjacent plies at respective joints, for example second end 501b of ply 501 abuts first end 502a of ply 502, second end 502b of ply 502 abuts first end 503a of ply 503, and so on, thereby creating ten butt splices in the fourth layer. Furthermore, plies 500, 501, 502, . . . 509 of CFRP may be applied to the third layer such that the butt joints of the fourth layer are offset from the butt joints of each of the lower layers.

Further in accordance with the example fabrication process of forward spar 131, a fifth layer of CFRP may be applied to the fourth layer. The fifth layer of forward spar 131 may include a plurality of plies of CFRP that are applied to the fourth layer. For example, as shown in FIG. 12E, the fifth layer of forward spar 131 may include ten plies 600, 601, 602, . . . 609 of CFRP. Each ply of CFRP may have a first end (e.g., 600a, 601a, 602a, . . . 609a) and an opposed second end (e.g., 600b, 601b, 602b, . . . 609b). Plies 600, 601, 602, . . . 609 of CFRP may be, for example T1100 0°-90° CFRP. Similar to fabrication of the second and fourth layers, plies 600, 601, 602, . . . 609 of CFRP may be laid up on the preform tool and trimmed before being applied to the fourth layer. Plies 600, 601, 602, . . . 609 of CFRP may be laid up on the preform tool such that alternating filaments of carbon fiber in the CFRP, for example the 0° filaments, are aligned (e.g., radially) toward axis 122.

As shown in FIG. 12E, when applied to the fourth layer, the ends of each ply 600, 601, 602, . . . 609 of CFRP may abut corresponding ends of adjacent plies at respective joints, for example second end 601b of ply 601 abuts first end 602a of ply 602, second end 602b of ply 602 abuts first end 603a of ply 603, and so on, thereby creating ten butt splices in the fifth layer. Furthermore, plies 600, 601, 602, . . . 609 of CFRP may be applied to the fourth layer such that the butt joints of the fifth layer are offset from the butt joints of each of the lower layers.

Further in accordance with the example fabrication process of forward spar 131, a sixth layer of CFRP may be applied to the fifth layer. The fifth layer of forward spar 131 may include a single ply 700 of CFRP that is applied to the fifth layer. Single ply 700 of CFRP may be, for example T1100±45° CFRP. The CFRP of single ply 700 may be applied to the fifth layer such that intersections in the weave are oriented toward axis 122. Single ply 700 of CFRP may have a length from first end 700a to second end 700b such that when single ply 700 is applied to the second layer, first and second ends 700a and 700b, respectively, abut each other, thereby creating a single butt splice in the sixth layer. As shown in FIG. 12F, single ply 700 of CFRP may be applied to the second layer such that the butt joint of the sixth layer is offset from the butt joints of each of the lower layers.

Further in accordance with the example fabrication process of forward spar 131, a seventh layer of CFRP may be applied to the sixth layer. The seventh layer of forward spar 131 may include a plurality of plies of CFRP that are applied to the sixth layer. For example, as shown in FIG. 12G, the seventh layer of forward spar 131 may include ten plies 800, 801, 802, . . . 809 of CFRP. Each ply of CFRP may have a first end (e.g., 800a, 801a, 802a, . . . 809a) and an opposed second end (e.g., 800b, 801b, 802b, . . . 809b). Plies 800, 801, 802, . . . 809 of CFRP may be, for example T1100 0°-90° CFRP. Similar to fabrication of the second, fourth, and fifth layers, plies 800, 801, 802, . . . 809 of CFRP may be laid up on the preform tool and trimmed before being applied to the sixth layer. Plies 800, 801, 802, . . . 809 of CFRP may be laid up on the preform tool such that alternating filaments of carbon fiber in the CFRP, for example the 0° filaments, are aligned (e.g., radially) toward axis 122.

As shown in FIG. 12G, when applied to the sixth layer, the ends of each ply 800, 801, 802, . . . 809 of CFRP may abut corresponding ends of adjacent plies at respective joints, for example second end 801b of ply 801 abuts first end 802a of ply 802, second end 802b of ply 802 abuts first end 803a of ply 803, and so on, thereby creating ten butt splices in the seventh layer. Furthermore, plies 800, 801, 802, . . . 809 of CFRP may be applied to the sixth layer such that the butt joints of the seventh layer are offset from the butt joints of each of the lower layers.

Further in accordance with the example fabrication process of forward spar 131, an eighth layer of CFRP may be applied to the seventh layer. The eighth layer of forward spar 131 may include a single ply 900 of CFRP that is applied to the seventh layer. Single ply 900 of CFRP may be, for example T1100±45° CFRP. The CFRP of single ply 900 may be applied to the seventh layer such that intersections in the weave are oriented toward axis 122. Single ply 900 of CFRP may have a length from first end 900a to second end 900b such that when single ply 900 is applied to the second layer, first and second ends 900a and 900b, respectively, abut each other, thereby creating a single butt splice in the eighth layer. As shown in FIG. 12H, single ply 900 of CFRP may be applied to the seventh layer such that the butt joint of the eighth layer is offset from the butt joints of each of the lower layers.

The individual layers of forward spar 131 may be applied such that forward spar 131 exhibits uniform thickness throughout plate 133, first circumferential flange 143, and second circumferential flange 145. Further in accordance with the example fabrication process of forward spar 131, when the eight layers have been assembled, a curing process may be performed on the matrix of the CFRP. Forward spar 131 may be further prepped before the curing process is initiated. For example, one or more caul tools may be applied to respective portions of forward spar 131 prior to commencing the curing process. Additionally, forward spar 131 may be enclosed, for instance in a vacuum wrap as shown in FIG. 13, before the curing process is initiated. The curing process may include heating forward spar 131 in an autoclave. Once the resin matrix of forward spar 131 is cured, the finished product may be released from tooling apparatus 171, for example by at least partially disassembling layup tool 173.

In accordance with the above-described example fabrication process, a forward spar 131 may be additively constructed of eight layers of CFRP. Stated differently, the composite material of a spar fabricated via the example process may comprise carbon fiber, and the spar may be constructed from a plurality of layers of carbon fiber. It should be appreciated that the plies of CFRP within the individual layers may define respective portions of plate 133, first circumferential flange 143, and second circumferential flange 145 of forward spar 131.

An annular aircraft spar constructed from composite material in accordance with the example fabrication process described herein may exhibit advantages not realized by annular spars constructed of other materials, such as metal. For example, an annular spar constructed from layers of CFRP, such as forward spar 131 and aft spar 151, may exhibit one or more characteristics that promote retention of its shape during operation of aircraft 101. For example, the CFRP preferably provides a coefficient of thermal expansion (CTE) that is sufficiently low such that the respective tip gaps in ducts 107 remain essentially constant throughout a range of operating temperatures that includes from about 25° F. to about 120° F.

It should be appreciated that the example fabrication process as described herein for fabricating forward spar 131 may also be used to fabricate aft spar 151. It should further be appreciated that the fabrication of a composite-material spar, such as forward spar 131 or aft spar 151, is not limited to the particular steps of the example fabrication process described herein. For example, a composite-material spar may have more or fewer layers of CFRP, may have more or fewer plies in respective layers that include a plurality of plies of CFRP, may have differently aligned filament orientations within the CFRP, and so on.

It should further still be appreciated that fabrication of an annular spar from composite material, such as CFRP, is not limited to the additive construction techniques of the example fabrication process described herein, and that an annular composite-material spar may be alternatively fabricated by incorporating or substituting other composite-material techniques. For example, prefabricated sections of carbon fiber (e.g., ‘braided socks’ of pre-woven carbon fiber) may be substituted for the trimmed and laid up and/or preformed layers of CFRP described herein. Such braided socks of carbon fiber may be implemented as part of a resin transfer molding process, a vacuum assisted resin transfer molding process, or the like for example. Additionally, other composite materials such as carbon-filled PEEK, thermoplastics, etc. and associated fabrication techniques such as extrusion, pulltrusion, etc. may be incorporated into the fabrication of an annular composite-material spar. It should further still be appreciated that composite-material spars as described herein may be suitable for deployment in aircraft having other configurations, for example in fixed (non-pivotable) ducted-rotor aircraft, in turbofan engines, or the like. It should further still be appreciated that duct 107 is not limited to an implementation having two spars such as upper spar 131 and lower spar 151. For example, duct 107 may be alternatively implemented with more or fewer spars.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A spar for a ducted rotor of an aircraft, the spar comprising:
an annular plate that defines an upper surface, a lower surface, an outer edge, and an inner edge;
a first circumferential flange that extends away from the upper surface along the outer edge of the plate; and
a second circumferential flange that extends away from the lower surface along the inner edge of the plate,
wherein the plate, the first circumferential flange, and the second circumferential flange are constructed of composite material.

2. The spar of claim 1, wherein the first circumferential flange tapers inwardly from the outer edge of the plate, toward a center axis of the spar.

3. The spar of claim 2, wherein the second circumferential flange tapers inwardly from the inner edge of the plate, toward the center axis of the spar.

4. The spar of claim 1, wherein the composite material comprises carbon-fiber-reinforced plastic (CFRP) and the spar is constructed from a plurality of layers of CFRP.

5. The spar of claim 4, wherein at least a first layer of the plurality of layers comprises a single ply of CFRP that defines opposed first and second ends, the first and second ends abutting each other at a joint.

6. The spar of claim 5, wherein at least a second layer of the plurality of layers comprises a plurality of plies of CFRP, each ply of the plurality of plies defining opposed first and second ends that abut corresponding ends of adjacent plies of the plurality of plies at respective joints.

7. The spar of claim 6, wherein within each of the plurality of plies, alternating filaments of carbon fiber in the CFRP are aligned toward a center axis of the spar.

8. The spar of claim 1, wherein the spar exhibits uniform thickness throughout the plate, the first circumferential flange, and the second circumferential flange.

9. A method of producing a spar for a ducted-rotor aircraft, the method comprising:
applying to an annular layup tool, as a first layer of the spar, a single ply of carbon-fiber-reinforced plastic (CFRP) that defines opposed first and second ends, such that the first and second ends abut each other;
applying to the first layer of the spar, as a second layer of the spar, a plurality of plies of CFRP, each ply of the plurality of plies defining opposed first and second ends that abut corresponding ends of adjacent plies at respective joints; and
performing a curing process on a matrix of the CFRP.

10. The method of claim 9, wherein each of the plurality of plies of CFRP are laid up on a preform tool and trimmed before being applied to the first layer.

11. The method of claim 10, wherein each of the plurality of plies of CFRP are laid up on the preform tool such that alternating filaments of carbon fiber in the CFRP are aligned toward a center axis of the spar.

12. The method of claim 10, wherein each of the plurality of plies of CFRP are laid up on the preform tool such that each ply conforms to a surface geometry of the first layer.

13. The method of claim 9, the method further comprising applying a caul tool to at least a portion of the spar prior to performing the curing process.

14. A spar for a ducted rotor of an aircraft, the spar comprising:
a first layer produced by applying a single ply of carbon-fiber-reinforced plastic (CFRP) to an annular layup tool such that opposed first and second ends of the single ply of CFRP abut each other; and
a second layer produced by applying, to the first layer of the spar, a plurality of plies of CFRP such that respective opposed ends of each ply of the plurality of plies abut corresponding ends of adjacent plies at respective joints.

15. The spar of claim 14, wherein the first layer is applied to the layup tool such that the spar defines:
an annular plate having an upper surface, a lower surface, an outer edge, and an inner edge;
a first circumferential flange that extends away from the upper surface along the outer edge of the plate; and
a second circumferential flange that extends away from the lower surface along the inner edge of the plate.

16. The spar of claim 15, wherein each of the plurality of plies of CFRP are laid up on a preform tool before being applied to the first layer.

17. The spar of claim 16, wherein the preform tool causes each of the plurality of plies of CFRP to conform to the annular plate, the first circumferential flange, and the second circumferential flange of the first layer.

18. The spar of claim 16, wherein each of the plurality of plies of CFRP are laid up on the preform tool such that alternating filaments of carbon fiber in the CFRP are aligned toward a center axis of the spar.

19. The spar of claim 15, wherein the first circumferential flange tapers inwardly from the outer edge of the plate, toward a center axis of the spar, and
wherein the second circumferential flange tapers inwardly from the inner edge of the plate, toward the center axis of the spar.

20. The spar of claim 14, wherein each of the plurality of plies of CFRP are applied to the first layer such that alternating filaments of carbon fiber in the CFRP are aligned toward a center axis of the spar.
